(19) United States
(12) Patent Application Publication
(10) Pub. No.: US 2025/0259016 A1
(43) Pub. Date: Aug. 14, 2025

(54) PROCESSING APPARATUS, PROCESSING METHOD, AND NON-TRANSITORY COMPUTER-READABLE MEDIUM

(71) Applicant: NEC Corporation, Tokyo (JP)

(72) Inventors: Takuma NOZAWA, Tokyo (JP); Masafumi Oyamada, Tokyo (JP)

(73) Assignee: NEC Corporation, Tokyo (JP)

(21) Appl. No.: 19/036,431

(22) Filed: Jan. 24, 2025

(30) Foreign Application Priority Data
Feb. 9, 2024 (JP) 2024-018512

(51) Int. Cl. G06F 40/40; G06F 16/31; G06F 40/166; G06F 40/279

(52) U.S. Cl. CPC G06F 40/40; G06F 16/322; G06F 40/279; G06F 40/166

(57) ABSTRACT

To improve quality of an answer to be output from a large language model (LLM), a processing apparatus according to the present disclosure accepts an input of a question and an analysis perspective. Then, the processing apparatus repeatedly performs processing of generating an answer by inputting a prompt indicating a question and an analysis perspective to the LLM with use of an input question, and a new question generated based on the answer.

### TECHNICAL FIELD

This application is based upon and claims the benefit of priority from Japanese patent application No. 2024-18512, filed on Feb. 9, 2024, the disclosure of which is incorporated herein in its entirety by reference.

The present disclosure relates to a processing apparatus, a processing method, and a program.

### BACKGROUND ART

A technique for performing natural language processing such as a question and answer by using large language models (LLMs) has been widely used. In the technique, there is a task of improving quality of an answer to be output from the LLM. A related technique is disclosed in Japanese Patent No. 7313757.

The technique disclosed in Japanese Patent No. 7313757 generates a prompt in which a passage valid to an input question is added as reference information within a range of a predetermined character limit. The technique improves quality of an answer to be output from the LLM by generating a prompt as described above.

### SUMMARY

One example of an object of the present disclosure is to improve quality of an answer to be output from an LLM.

An example aspect of the present disclosure provides a processing apparatus including:
an input acceptance unit that accepts an input of a question and an analysis perspective; and
a search unit that repeatedly performs processing of generating an answer by inputting a prompt indicating a question and an analysis perspective to a large language model with use of an input question, and a new question generated based on the answer.

Further, an example aspect of the present disclosure provides a processing method including,
by one or more computers:
   accepting an input of a question and an analysis perspective; and
   repeatedly performing processing of generating an answer by inputting a prompt indicating a question and an analysis perspective to a large language model with use of an input question, and a new question generated based on the answer.

Further, an example aspect of the present disclosure provides a program that causes a computer to function as:
an input acceptance unit that accepts an input of a question and an analysis perspective; and
a search unit that repeatedly performs processing of generating an answer by inputting a prompt indicating a question and an analysis perspective to a large language model with use of an input question, and a new question generated based on the answer.

According to one example aspect of the present disclosure, it is possible to improve quality of an answer to be output from an LLM.

### BRIEF DESCRIPTION OF THE DRAWINGS

FIG. 1 is a diagram illustrating one example of a functional block diagram of a processing apparatus according to the present disclosure.

FIG. 2 is a flowchart illustrating one example of a flow of processing of the processing apparatus according to the present disclosure.

FIG. 3 is a diagram for describing an overview of the processing apparatus according to the present disclosure.

FIG. 4 is a diagram illustrating one example of a hardware configuration of the processing apparatus according to the present disclosure.

FIG. 5 is a diagram illustrating one example of a functional block diagram of the processing apparatus according to the present disclosure.

FIG. 6 is a diagram illustrating one example of a functional block diagram of a search unit according to the present disclosure.

FIG. 7 is a flowchart illustrating another example of a flow of processing of the processing apparatus according to the present disclosure.

FIG. 8 is a diagram for describing a flow of processing of the processing apparatus according to the present disclosure.

FIG. 9 is a diagram for describing one example of processing of the processing apparatus according to the present disclosure.

FIG. 10 is a diagram for describing another example of processing of the processing apparatus according to the present disclosure.

FIG. 11 is a diagram for describing another example of processing of the processing apparatus according to the present disclosure.

FIG. 12 is a diagram for describing another example of processing of the processing apparatus according to the present disclosure.

FIG. 13 is a diagram for describing another example of processing of the processing apparatus according to the present disclosure.

FIG. 14 is a diagram for describing another example of processing of the processing apparatus according to the present disclosure.

FIG. 15 is a diagram for describing another example of processing of the processing apparatus according to the present disclosure.

FIG. 16 is a diagram illustrating one example of information to be output from the processing apparatus according to the present disclosure.

FIG. 17 is a diagram for describing another example of processing of the processing apparatus according to the present disclosure.

FIG. 18 is a diagram for describing another example of processing of the processing apparatus according to the present disclosure.

### EXAMPLE EMBODIMENT

Hereinafter, example embodiments according to the present disclosure are described by using the drawings. In the present disclosure, drawings are associated with one or more example embodiments. Further, in all the drawings, a similar constituent element is indicated by a similar reference sign, and description thereof is omitted as necessary.

### First Example Embodiment

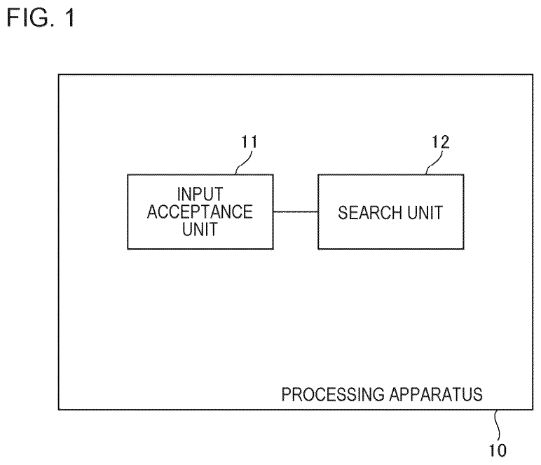

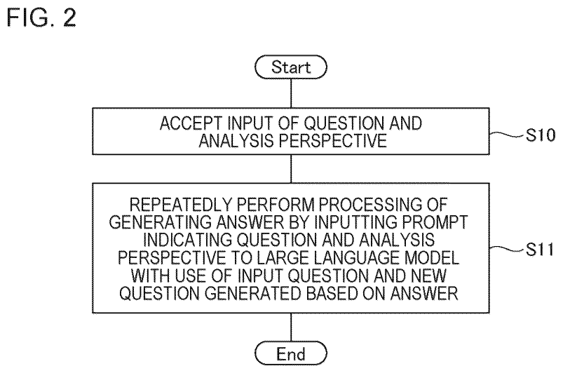

FIG. 1 is a functional block diagram illustrating an overview of a processing apparatus 10. FIG. 2 is a flowchart illustrating one example of a flow of processing to be performed by the processing apparatus 10.

As illustrated in FIG. 1, the processing apparatus 10 includes an input acceptance unit 11, and a search unit 12. Processing of the flowchart in FIG. 2 is performed by these functional units.

In S10, the input acceptance unit 11 accepts an input of a question and an analysis perspective.

In S11, the search unit 12 repeatedly performs processing of generating an answer by inputting a prompt indicating a question and an analysis perspective to an LLM with use of an input question, and a new question generated based on the answer.

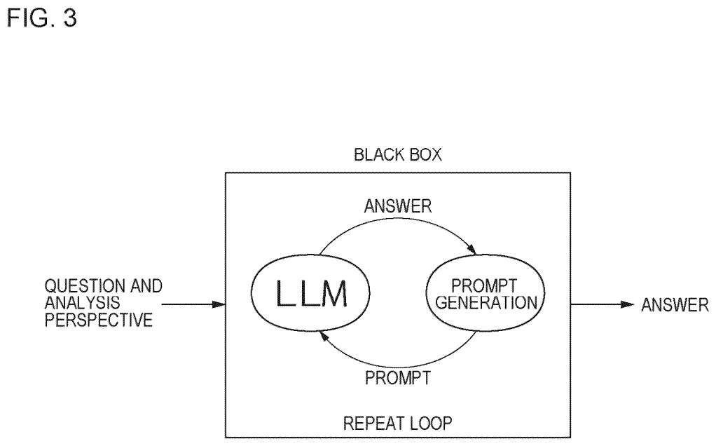

Specifically, as illustrated in FIG. 3, in a case where an input of a question and an analysis perspective is accepted, the processing apparatus 10 repeats processing of generating an answer by inputting a prompt to the LLM. According to the processing apparatus 10 that repeats processing as described above, it is possible to imitate behavior of a human who thinks deeply by repeating thought. Thus, an answer of higher quality can be generated.

Further, the processing apparatus 10 automatically generates a prompt, and inputs the generated prompt to the LLM during processing to be repeatedly performed. Specifically, a user only needs to input a question and an analysis perspective once for a first time, and does not need to input a prompt every time during processing to be repeatedly performed. In this way, the processing apparatus 10 can imitate behavior of a human who thinks deeply by repeating thought, without an effort of a user. Thus, an answer of higher quality can be generated.

Further, the processing apparatus 10 can generate a question, based on an answer, and generate a prompt by using a generated new question. According to the processing apparatus 10 as described above, after acquiring a result of thought, behavior of a human who thinks further deeply, based on the result, can be imitated. Thus, an answer of higher quality can be generated.

Further, the processing apparatus 10 can acquire an answer by inputting, to the LLM, a prompt indicating not only a question but also an analysis perspective. Adding an analysis perspective enables to generate an answer of higher quality.

### Second Example Embodiment

### Overview

A processing apparatus 10 according to a second example embodiment is an embodiment that embodies the configuration of the processing apparatus 10 according to the first example embodiment. Hereinafter, details are described.

### Hardware Configuration

First, one example of a hardware configuration of the processing apparatus 10 is described. Each functional unit of the processing apparatus 10 is achieved by any combination of hardware and software. A person skilled in the art may naturally understand that there are various modification examples, as a method and an apparatus of achieving the configuration. The software includes a program stored in advance at a stage of shipping an apparatus, a program downloaded from a medium such as a compact disc (CD), a server or the like on the Internet, and the like.

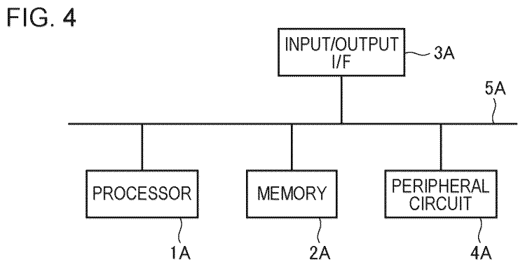

FIG. 4 is a block diagram illustrating a hardware configuration of the processing apparatus 10. As illustrated in FIG. 4, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be composed of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is an arithmetic processing apparatus, for example, such as a central processing unit (CPU) and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Further, the input/output interface 3A includes an interface for connecting to a communication network such as the Internet. The input apparatus is, for example, a keyboard, a mouse, a microphone, a physical button, a touch panel, and the like. The output apparatus is, for example, a display, a projection apparatus, a speaker, a printer, a mailer, and the like. The processor 1A can issue a command to each module, and perform an arithmetic operation, based on these arithmetic operation results.

### Functional Configuration

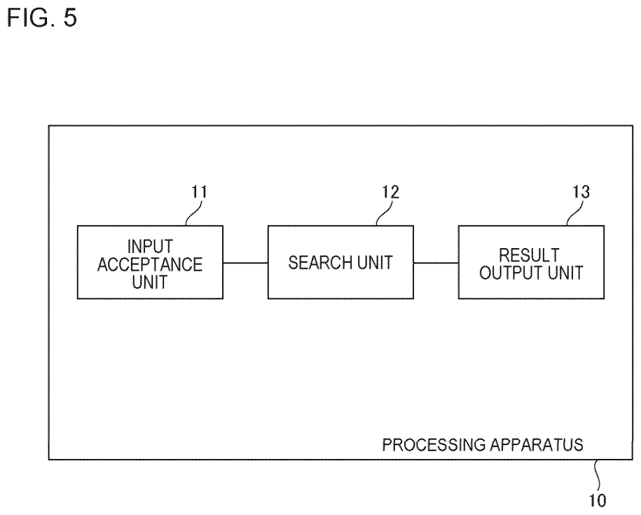

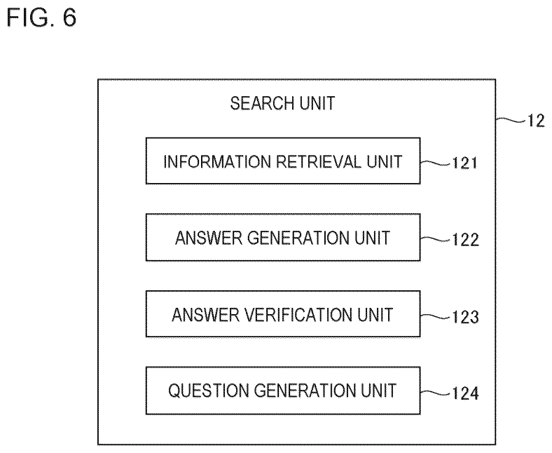

Next, a functional configuration of the processing apparatus 10 is described in detail. FIG. 5 illustrates one example of a functional block diagram of the processing apparatus 10. As illustrated in FIG. 5, the processing apparatus 10 includes an input acceptance unit 11, a search unit 12, and a result output unit 13. Further, as illustrated in FIG. 6, the search unit 12 includes an information retrieval unit 121, an answer generation unit 122, an answer verification unit 123, and a question generation unit 124.

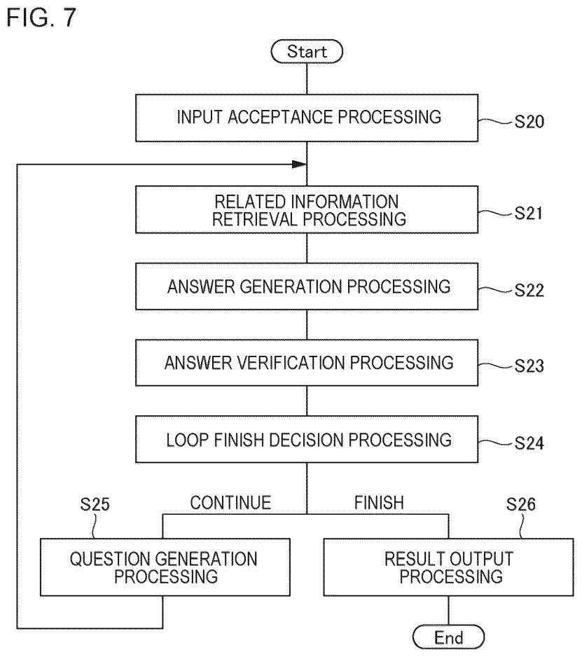

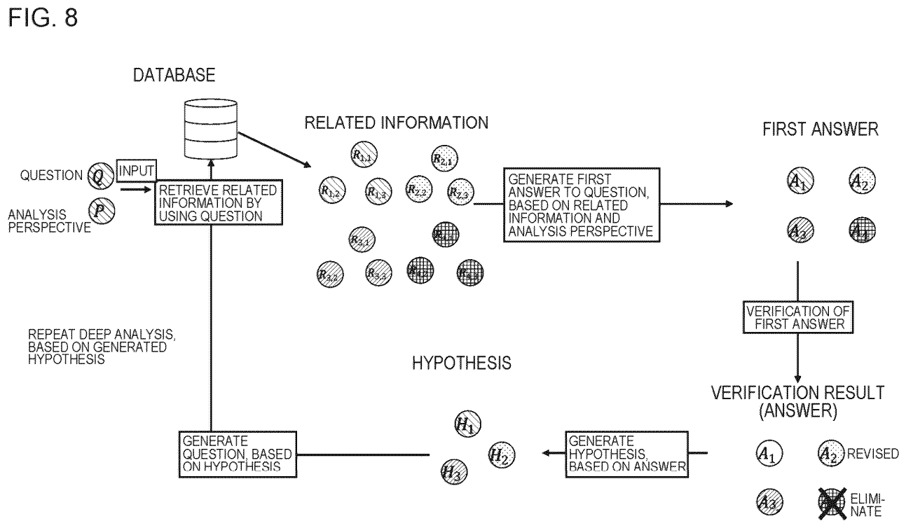

By these functional units, processing illustrated in a flowchart in FIG. 7 is performed. An overview of each piece of processing, and an overall image of processing are described with reference to FIG. 8.

Input acceptance processing S20: The input acceptance unit 11 accepts an input of a question and an analysis perspective. For example, as illustrated in FIG. 8, the input acceptance unit 11 accepts an input of a question Q and an analysis perspective P.

Related information retrieval processing S21: The information retrieval unit 121 retrieves related information related to a question. For example, as illustrated in FIG. 8, the information retrieval unit 121 retrieves, from among information stored in a database, pieces of related information R_{1.1} to R_{4.3} related to the question Q.

Answer generation processing S22: The answer generation unit 122 generates a prompt by using a question, an analysis perspective, and related information, and generates a first answer by inputting the generated prompt to an LLM. For example, the information retrieval unit 121 generates a prompt by using the question Q, the analysis perspective P, and the pieces of related information R_{1.1} to R_{4.3} illustrated in FIG. 8, and generates first answers A₁ to A₄ by inputting the generated prompt to the large language model.

Answer verification processing S23: The answer verification unit 123 decides whether a degree of relevance between a first answer and a question satisfies a passing condition, and outputs, as an answer, a first answer that satisfies the passing condition. For example, the answer verification unit 123 decides whether a degree of relevance between the question Q, and each of the first answers A₁ to A₄ illustrated in FIG. 8 satisfies a passing condition. Then, the answer verification unit 123 outputs, toward next piece of processing, the first answers A₁ to A₃ that satisfy the passing condition, as an answer. Note that, as illustrated in FIG. 8, the answer verification unit 123 may discard the first answer A₄ that does not satisfy the passing condition, without outputting the first answer A₄ toward the next piece of processing. Further, as illustrated in FIG. 8, the answer verification unit 123 may revise the first answer A₂ that does not satisfy the passing condition, and output, toward the next piece of processing, the first answer A₂ after revision that satisfies the passing condition, as an answer.

Loop finish decision processing S24: The answer verification unit 123 decides whether a loop is to be finished. In a case where the loop is not finished, the processing apparatus 10 proceeds to question generation processing S25. In a case where the loop is finished, the processing apparatus 10 proceeds to result output processing S26.

Question generation processing S25: The question generation unit 124 generates a hypothesis, based on an answer output in the answer verification processing S23, and generates a new question, based on the generated hypothesis. For example, as illustrated in FIG. 8, the question generation unit 124 generates hypotheses H₁ to H₃, based on each of the answers A₁ to A₃ output in the answer verification processing S23. Then, the answer generation unit 124 generates a new question, based on each of the generated hypotheses H₁ to H₃. Thereafter, the processing apparatus 10 returns to the related information retrieval processing S21, and repeats similar processing. In processing at a second time and thereafter, a new question generated in the question generation processing S25 is used, in place of the question Q input in the input acceptance processing S20.

Result output processing S26: A result is output.

Next, each piece of processing is described in detail.

### Input Acceptance Processing S20

The input acceptance unit 11 accepts an input of a question and an analysis perspective. The question is composed of, for example, a passage. The analysis perspective is composed of, for example, a word or a passage.

An input format of the question and the analysis perspective is not particularly limited. For example, a free description style may be adopted. In this case, the input acceptance unit 11 can decrypt an input content by using a technique such as morphological analysis, and determine the question and the analysis perspective. One example of the input is described below. A content in parentheses is data input by a user.
(Input example 1) “What is a task of data utilization? An analysis perspective is a task, a cause, and a solution.”
(Input example 2) “Regarding a task of data utilization, answer in terms of an analysis perspective of a task, a cause, and a solution.”

In addition, the input acceptance unit 11 may individually provide, on a user interface (UI) screen for accepting an input, a column in which an input of a question is accepted, and a column in which an input of an analysis perspective is accepted. Then, the input acceptance unit 11 may accept, as a question, a content input in the question column, and accept, as an analysis perspective, a content input in the analysis perspective column. One example of the input is described below. A content in parentheses is data input by a user.
(Input example 3) Question column: “What is a task of data utilization?” Analysis perspective column: “a task, a cause, and a solution.”

The input acceptance unit 11 can accept the above-described input via any input apparatus such as a keyboard, a touch panel, a mouse, a microphone, and a physical button. Further, the processing apparatus 10 may be a server. In this case, the input acceptance unit 11 can receive a question and an analysis perspective transmitted from a client terminal.

### Related Information Retrieval Processing S21

The information retrieval unit 121 retrieves related information related to a question.

As described by using FIGS. 7 and 8, the processing apparatus 10 repeats a loop. In a loop at a first time, the information retrieval unit 121 can retrieve related information related to a question input in the input acceptance processing S20. Then, in a loop at a second time and thereafter, the information retrieval unit 121 can retrieve related information related to a new question generated by the question generation unit 124.

The related information is document data, image data (a drawing, a photograph, and the like), data in another format (a table and the like), and the like, but is not limited thereto. A source (retrieval destination) of the related information may be one or plural. The related information may be information widely and publicly available on a web. Further, the related information may be locally saved information. The locally saved information may be data prepared for processing by the processing apparatus 10, or may be information publicly available in such a way as to be widely utilized in local.

The information retrieval unit 121 can acquire related information by using a retrieval model that performs retrieval of related information, based on a certain degree of relevance to a question.

For example, the information retrieval unit 121 may retrieve related information by using a web retrieval engine. In a case of this example, the information retrieval unit 121 performs retrieval by inputting a question to the web retrieval engine. Then, the information retrieval unit 121 acquires, as related information related to the input question, information on a webpage included in a result of the retrieval. In a case where the number of hits of retrieval results is large, the information retrieval unit 121 may acquire, as related information, information on a predetermined top number of retrieval results.

In addition, the information retrieval unit 121 may perform retrieval by inputting a question to a retrieval engine that retrieves locally saved information. Then, the information retrieval unit 121 may acquire, as related information related to the input question, local information included in a result of the retrieval. In a case where the number of hits of retrieval results is large, the information retrieval unit 121 may acquire, as related information, information on a predetermined top number of retrieval results.

Note that, a method exemplified herein is merely one example, and the information retrieval unit 121 may retrieve related information related to a question by another method.

Meanwhile, actually (in a case where a person decides), there is a possibility that data (noise data) in which a degree of relevance to a question is low may be included in related information retrieved by a method as described above. In view of the above, the information retrieval unit 121 may perform processing of eliminating noise data from retrieved related information.

For example, the information retrieval unit 121 may compute a degree of relevance between a question and retrieved related information, and eliminate, as noise data, related information in which the degree of relevance is equal to or less than a threshold value. The information retrieval unit 121 can compute a degree of relevance between a question and retrieved related information by using a relationship decision model being prepared in advance.

As one example of the relationship decision model, upon accepting an input of a question and retrieved related information, similarity between the question and the retrieved related information is output as a degree of relevance. In this case, the information retrieval unit 121 eliminates, as noise data, related information in which the similarity (degree of relevance) to the question is equal to or less than a threshold value.

In recent years, a technique for computing similarity between passages is widely used. In one example, a passage is converted into a vector, and similarity (cosine similarity or the like) between vectors is computed as similarity between passages. One example of the relationship decision model can compute similarity between a question and retrieved related information by using a technique as described above.

Note that, in a case where related information is image data such as a drawing and a photograph, the information retrieval unit 121 may generate document data from the image data by using a learning model that has trained in such a way as to generate, from the image data, document data representing an image. Then, the information retrieval unit 121 may compute, as similarity (degree of relevance) between image data and a question, similarity between the generated document data and the question. Also in a case where related information is data in another format such as a table, it is possible to compute similarity (degree of relevance) between a question and retrieved related information by a method similar to that for image data.

Another example of the relationship decision model is an LLM. The LLM is a model of natural language processing being trained by using a large amount of text data. For example, in a case where a query is input to the LLM, an answer to the query is output from the LLM. A passage (query) to be input to the LLM is referred to as a “prompt”.

The information retrieval unit 121 may generate a prompt asking for whether a question and retrieved related information are related to each other, input the generated prompt to the LLM, and thereby acquire a query as to whether the question and the retrieved related information are related to each other. Then, the information retrieval unit 121 may eliminate, as noise data, related information in which the answer is “not related”. Various examples are conceived for a prompt in this processing, however, one example is as follows.

“Are the following question and related information related to each other? In a case where they are related to each other, output 1, and in a case where they are not related to each other, output 0.
[Question] What is a task of data utilization?
[Related information] Recent . . . ”

The information retrieval unit 121 may generate a prompt, for example, by using a template being prepared in advance. For example, the template may be a passage in which a position where a question is inserted, and a position where related information is inserted are blank. Then, the information retrieval unit 121 may generate a prompt by inserting the question and the related information to a predetermined position of the template. In addition, the information retrieval unit 121 may generate a prompt on the basis of a generation model, in place of generating a prompt on the basis of a template. The generation model herein can be achieved by using any widely known technique.

### Answer Generation Processing S22

The answer generation unit 122 generates a prompt (hereinafter, may also referred to as a “prompt for first answer generation” by using a question, an analysis perspective, and related information, and generates a first answer by inputting the generated prompt for first answer generation to the LLM.

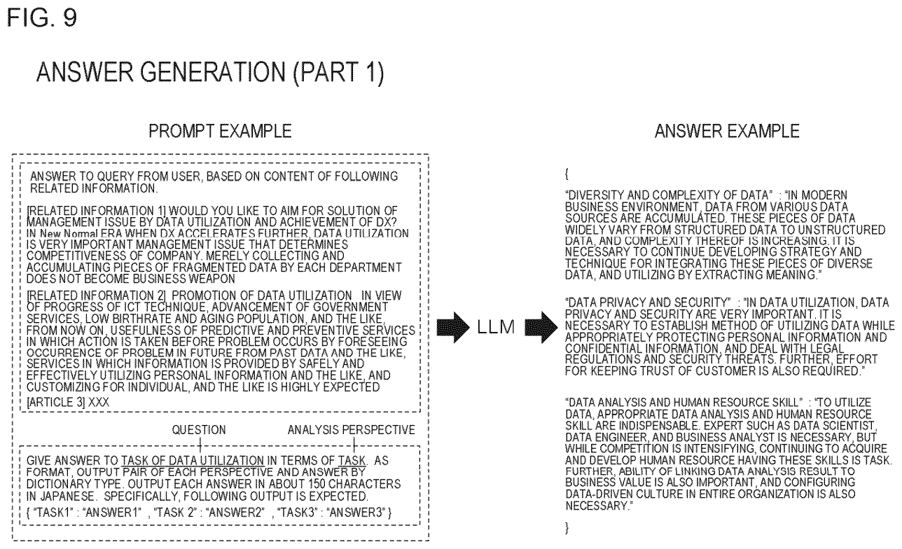

One example is illustrated in FIG. 9. A prompt example in FIG. 9 is one example of a prompt for first answer generation. Further, an answer example in FIG. 9 is one example of a first answer output from the LLM. As illustrated in FIG. 9, the LLM may generate and output a plurality of first answers (in a case of the example in FIG. 9, three first answers) in response to one input of a prompt for first answer generation. Note that, the LLM may generate and output one first answer in response to one input of a prompt for first answer generation.

The answer generation unit 122 can generate a prompt for first answer generation, for example, by using a template being prepared in advance. For example, the template may be a passage in which a position where a question is inserted, a position where an analysis perspective is inserted, and a position where related information is inserted are blank. Then, the answer generation unit 122 may generate a prompt for first answer generation by inserting the question, the analysis perspective, and the related information to a predetermined position of the template. In addition, the answer generation unit 122 may generate a prompt for first answer generation on the basis of a generation model, in place of generating a prompt for first answer generation on the basis of a template. The generation model herein can be achieved by using any widely known technique.

The answer generation unit 122 can refer to related information, after giving the related information to a context of the LLM, and generate a prompt for first answer generation asking for an answer to a question in terms of a specified analysis perspective. A first answer to be acquired by a prompt for first answer generation as described above is an “answer to a question” that is generated by referring to related information, and is related to a specified analysis perspective. A technique for using related information as described above is known as retrieval augmented generation (RAG).

As described by using FIGS. 7 and 8, the processing apparatus 10 repeats a loop. In a loop at a first time, the answer generation unit 122 can ask for an answer to a question input in the input acceptance processing S20. Related information included in a prompt for first answer generation in the loop at the first time is related information related to the question input in the input acceptance processing S20.

Then, in a loop at a second time and thereafter, the answer generation unit 122 can ask for an answer to a new question generated by the question generation unit 124. Related information included in a prompt for first answer generation in the loop at the second time and thereafter is related information related to a new question generated by the question generation unit 124.

An analysis perspective included in a prompt for first answer generation is decided, for example, based on an analysis perspective input in the input acceptance processing S20.

It is preferable to differentiate an analysis perspective included in a prompt for first answer generation in a loop at each of a plurality of times. Specifically, as illustrated in FIGS. 7 and 8, in processing to be repeatedly performed, it is preferable to differentiate an analysis perspective for use in processing at each time. Performing as described above achieves deepening of thought in various perspectives, as the loop is repeated.

One analysis perspective may be included, or a combination of a plurality of analysis perspectives may be included in a prompt for first answer generation.

In a case where only one analysis perspective is included in a prompt for first answer generation, the answer generation unit 122 can select, for example, each one of a plurality of analysis perspectives input in the input acceptance processing S20, and include the selected analysis perspective in a prompt for first answer generation in each of a plurality of loops.

Performing as described above enables to narrow down thought in a loop at each time to one analysis perspective. Consequently, a possibility of acquiring, from the LLM, an answer of high accuracy in which the one analysis perspective is deepened increases.

On the other hand, in a case where including a plurality of analysis perspectives in a prompt for first answer generation is permitted, the answer generation unit 122 generates all combinations composed of at least one constituent element (analysis perspective) by using, for example, a plurality of analysis perspectives input in the input acceptance processing S20. Then, the answer generation unit 122 can select each one pair among the plurality of generated combinations, and include the selected pair in a prompt for first answer generation in each of a plurality of loops.

In this case, it is assumed that “analysis perspective A”, and “analysis perspective A+analysis perspective B” are combinations of different analysis perspectives. Although both of the combinations include a same analysis perspective being “analysis perspective A”, there is a possibility that an answer of the LLM may be different, in a case where the analysis perspective A is combined with another analysis perspective. Acquiring an answer from the LLM by using combinations of various analysis perspectives achieves deepening of thought in terms of various perspectives.

Note that, the answer generation unit 122 may include, in a prompt for first answer generation, an analysis perspective other than an analysis perspective input in the input acceptance processing S20. For example, a candidate of an analysis perspective may be registered in advance in the processing apparatus 10. Then, the answer generation unit 122 may decide, from among the candidate of the analysis perspective being registered in advance, an analysis perspective included in a prompt for first answer generation by a method similar to the above.

In addition, the answer generation unit 122 may generate a prompt asking for an analysis perspective preferable to a question, input the generated prompt to the LLM, and thereby acquire the analysis perspective preferable to the question. Then, the answer generation unit 122 may decide, from among the analysis perspective acquired as described above, an analysis perspective included in a prompt for first answer generation by a method similar to the above.

Various examples are conceived for a prompt in this processing, however, one example is as follows.
“Mention five analysis perspectives preferable to the following question.
[Question] What is a task of data utilization?”

The answer generation unit 122 may generate a prompt, for example, by using a template being prepared in advance. For example, the template may be a passage in which a position where a question is inserted is blank. Then, the answer generation unit 122 may generate a prompt by inserting the question to a predetermined position of the template. In addition, the answer generation unit 122 may generate a prompt on the basis of a generation model, in place of generating a prompt on the basis of a template. The generation model herein can be achieved by using any widely known technique.

Note that, the analysis perspective may include a perspective of a business framework such as a “human”, a “thing”, and “money”. Thus, an answer in which a perspective important for business is secured can be expected.

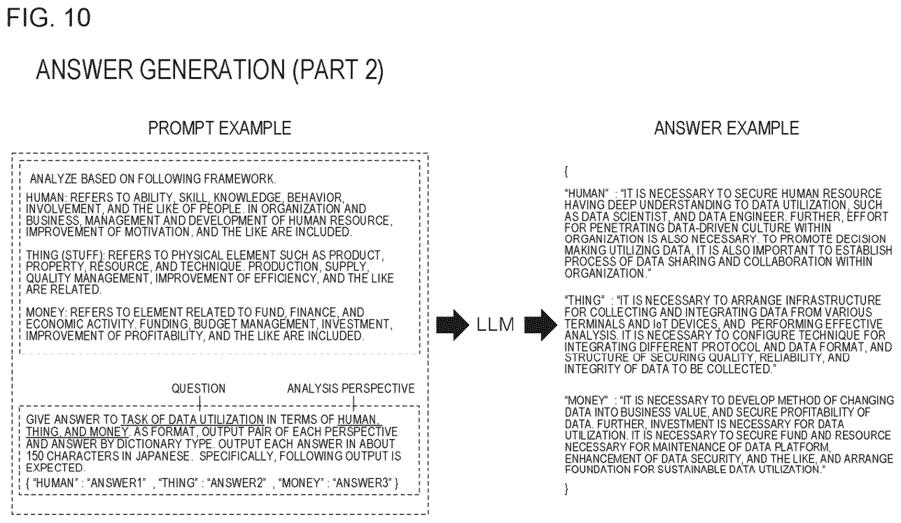

In this way, an analysis perspective included in a prompt for first answer generation is not specifically limited, and various analysis perspectives can be included. However, in a case as described above, there is a possibility that the LLM does not hold knowledge related to the analysis perspectives sufficiently. Consequently, accuracy of an answer of the LLM may be lowered. In view of the above, related information related to various analysis perspectives may be registered in advance in the processing apparatus 10. Further, as illustrated in FIG. 10, the answer generation unit 122 may further include, in a prompt for first answer generation, related information on an analysis perspective.

In addition, the information retrieval unit 121 my acquire related information related to an analysis perspective by a method similar to a method of acquiring related information related to a question. Further, the answer generation unit 122 may include, in a prompt for first answer generation, the related information on the analysis perspective acquired by a method as described above.

Including related information on an analysis perspective as described above in a prompt for first answer generation makes it easy to acquire an answer of high accuracy from the LLM.

Note that, in a case where related information is enormous, and cannot be stored in a context length available in the LLM, the answer generation unit 122 may select related information in descending order of a degree of relevance, and include the selected related information in a prompt for first answer generation. In addition, the answer generation unit 122 may generate a summary of related information by using the LLM, and include, in a prompt for first answer generation, the generated summary of the related information, in place of the related information.

Further, the answer generation unit 122 may classify related information for each topic, and generate a plurality of prompts for first answer generation including the related information of each topic. Then, the answer generation unit 122 may input, to the LLM, each of the plurality of prompts for first answer generation generated as described above, and generate an answer to a question in the LLM for each topic. In this case, the prompt for first answer generation associated with each topic includes related information of each topic, and does not include related information of another topic. Classification of the related information can be achieved by various methods. As one example, a method of vectorizing each piece of related information, and clustering based on similarity between vectors is exemplified, but the present example embodiment is not limited thereto.

### Answer Verification Processing S23

The answer verification unit 123 decides whether a degree of relevance between a first answer, and a question (question included in a prompt for first answer generation for acquiring the first answer) satisfies a passing condition. Then, the answer verification unit 123 may output, as an answer to the question, a first answer that satisfies the passing condition. The answer verification unit 123 may output, as an answer to the question, one first answer, or may output, as an answer to the question, a plurality of first answers. The processing enables to perform pieces of processing thereafter (generation of a question, loop processing based on a new question, output of a result, and the like), based on a first answer in which a degree of relevance to the question is high.

The answer verification unit 123 can decide, based on any of the following pieces of verification processing 1 to 4, whether a degree of relevance between a first answer and a question satisfies a passing condition.

### Verification Processing 1

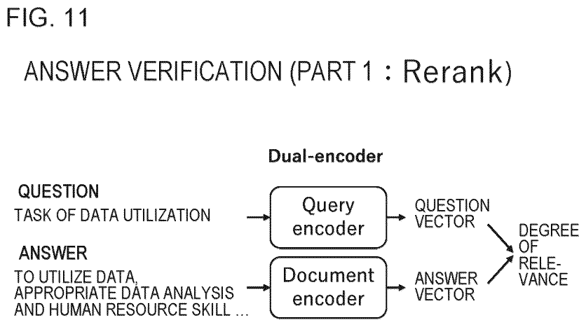

As illustrated in FIG. 11, the answer verification unit 123 can compute a degree of relevance between a first answer and a question by using a Dual-encoder. Then, in a case where the computed degree of relevance is equal to or more than a threshold value, the answer verification unit 123 can decide that the relationship between the first answer and the question satisfies a passing condition. On the other hand, in a case where the computed degree of relevance is less than the threshold value, the answer verification unit 123 can decide that the relationship between the first answer and the question does not satisfy the passing condition.

The Dual-encoder includes a Query encoder and a Document encoder.

Upon accepting an input of the question (passage), the Query encoder converts the question into a vector, and outputs the vector.

Upon accepting an input of the first answer (passage), the Document encoder converts the first answer into a vector, and outputs the vector.

Then, the answer verification unit 123 computes, as a degree of relevance between the first answer and the question, similarity (cosine similarity or the like) between the two vectors output from the two encoders.

### Verification Processing 2

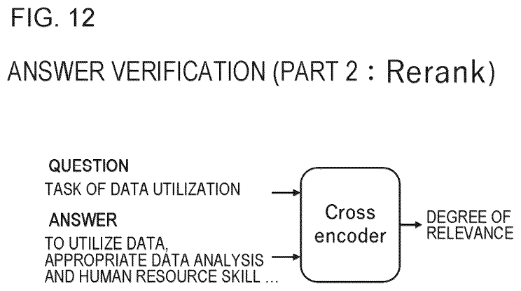

As illustrated in FIG. 12, the answer verification unit 123 can compute a degree of relevance between a first answer and a question by using a Cross encoder. Then, in a case where the computed degree of relevance is equal to or more than a threshold value, the answer verification unit 123 can decide that the relationship between the first answer and the question satisfies a passing condition. On the other hand, in a case where the computed degree of relevance is less than the threshold value, the answer verification unit 123 can decide that the relationship between the first answer and the question does not satisfy the passing condition.

Upon accepting an input of the question (passage) and the first answer (passage), the Cross encoder outputs a degree of relevance.

### Verification Processing 3

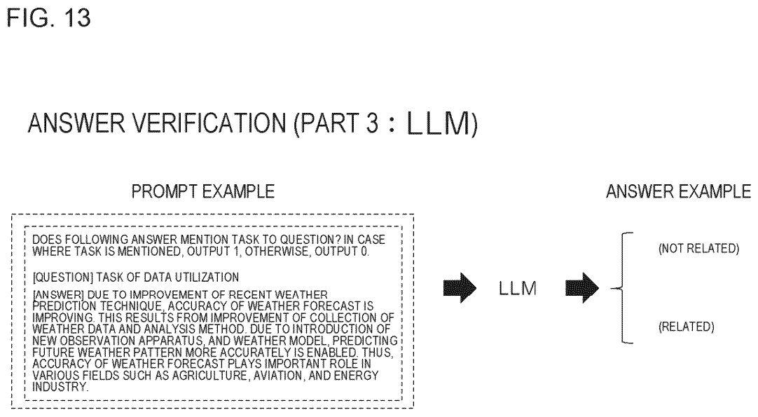

As illustrated in FIG. 13, the answer verification unit 123 can compute a degree of relevance between a first answer and a question by using the LLM.

The answer verification unit 123 can generate a prompt asking for whether a first answer and a question are related to each other, input the generated prompt to the LLM, and thereby acquire an answer as to whether the first answer and the question are related to each other. Then, in a case where the answer indicates “related”, the answer verification unit 123 can decide that the relationship between the first answer and the question satisfies a passing condition. On the other hand, in a case where the answer indicates “not related”, the answer verification unit 123 can decide that the relationship between the first answer and the question does not satisfy the passing condition.

Various examples are conceived for a prompt in this processing, however, one example is as illustrated in FIG. 13. The answer verification unit 123 may generate a prompt, for example, by using a template being prepared in advance. For example, the template may be a passage in which a position where a question is inserted, and a position where a first answer is inserted are blank. Then, the answer verification unit 123 may generate a prompt by inserting the question and the first answer to a predetermined position of the template. In addition, the template may be configured in such a way that a position (position of a “task” in FIG. 13) where an analysis perspective is inserted is blank. In addition, the answer verification unit 123 may generate a prompt on the basis of a generation model, in place of generating a prompt on the basis of a template. The generation model herein can be achieved by using any widely known technique.

### Verification Processing 4

The answer verification unit 123 can decide whether a degree of relevance between a first answer and a question satisfies a passing condition by a method in which at least two pieces of processing among the verification processing 1 to 3 are combined.

In a case of this example, in a case where a verification result of each of the plurality of pieces of verification processing satisfies a predetermined condition, the answer verification unit 123 decides that a degree of relevance between the first answer and the question satisfies the passing condition.

The predetermined condition is any of the following.
Relationship between a first answer and a question satisfies a passing condition in all of the plurality of pieces of verification processing
Relationship between a first answer and a question satisfies a passing condition in at least one of the plurality of pieces of verification processing
Relationship between a first answer and a question satisfies a passing condition by a predetermine ratio or more of the plurality of pieces of verification processing
Relationship between a first answer and a question satisfies a passing condition by a predetermined number or more of the plurality of pieces of verification processing
A rating value computed (e.g., added up) based on a weighting score of each of the pieces of verification processing in which it is decided that relationship between a first answer and a question satisfies a passing condition is equal to or more than a threshold value

Note that, in a case where a degree of relevance between a first answer and a question does not satisfy a passing condition, the answer verification unit 123 may discard the first answer. The processing enables to suppress an inconvenience that pieces of processing thereafter (generation of a question, loop processing based on a new question, output of a result, and the like) is performed based on a first answer in which a degree of relevance to a question is low.

In addition, in a case where a degree of relevance between a first answer and a question does not satisfy a passing condition, the answer verification unit 123 may revise the first answer. Then, the answer verification unit 123 may decide whether the degree of relevance between the first answer after revision and the question satisfies the passing condition. Then, the answer verification unit 123 may output, as an answer to the question, the first answer after revision that satisfies the passing condition. The processing enables to perform pieces of processing thereafter (generation of a question, loop processing based on a new question, output of a result, and the like), based on the first answer being revised in such a way that the degree of relevance to the question satisfies the passing condition.

Note that, in a case where a degree of relevance between a first answer and a question is lower than a predetermined level, the answer verification unit 123 may discard the first answer. Then, in a case where the degree of relevance between the first answer and the question is higher than the predetermined level, but does not satisfy a passing condition, the answer verification unit 123 may revise the first answer.

The predetermined level herein may be defined by a degree of relevance to be computed in the verification processing 1 and the verification processing 2.

In one example, in a case where a degree of relevance is less than a first threshold value, the answer verification unit 123 discards the first answer. Then, in a case where the degree of relevance is equal to or more than the first threshold value, but is less than a second threshold value, the answer verification unit 123 revises the first answer. Then, in a case where the degree of relevance is equal to or more than the second threshold value, the answer verification unit 123 decides that the first answer satisfies the passing condition.

In addition, the predetermined level herein may be defined based on a verification result of each of the plurality of pieces of verification processing.

In one example, a weighting score is determined in advance for each of the plurality of pieces of verification processing. Then, the answer verification unit 123 computes (e.g., adds up) a rating value of a first answer, based on a weighting score of each of the pieces of verification processing in which it is decided that a passing condition is satisfied.

Then, in a case where the rating value is less than a first threshold value, the answer verification unit 123 discards the first answer. Then, in a case where the rating value is equal to or more than the first threshold value, but is less than a second threshold value, the answer verification unit 123 revises the first answer. Then, in a case where the rating value is equal to or more than the second threshold value, the answer verification unit 123 decides that the first answer satisfies the passing condition.

Next, processing of revising a first answer is described. The answer verification unit 123 can perform any of the following pieces of revision processing 1 and 2.

### Revision Processing 1

The answer verification unit 123 can generate a prompt asking for revision of a first answer, input the generated prompt to the LLM, and thereby acquire a first answer after revision. Various examples are conceived for a prompt in this processing, however, one example is as follows.

“Revise the following first answer to the following question in such a way as to increase a degree of relevance to the question.
[Question] What is a task of data utilization? [First answer] To utilize data, . . . ”

The answer verification unit 123 may generate a prompt, for example, by using a template being prepared in advance. For example, the template may be a passage in which a position where a question is inserted, and a position where a first answer is inserted are blank. Then, the answer verification unit 123 may generate a prompt by inserting the question and the first answer to a predetermined position of the template. In addition, the answer verification unit 123 may generate a prompt on the basis of a generation model, in place of generating a prompt on the basis of a template. The generation model herein can be achieved by using any widely known technique.

### Revision Processing 2

In a case where a first answer is revised by using the LLM, in a case where a content of a prompt is inappropriate, desired revision may not be performed, and a content after revision may become almost the same as the content before revision. To suppress the inconvenience, the answer verification unit 123 can generate a prompt as follows.

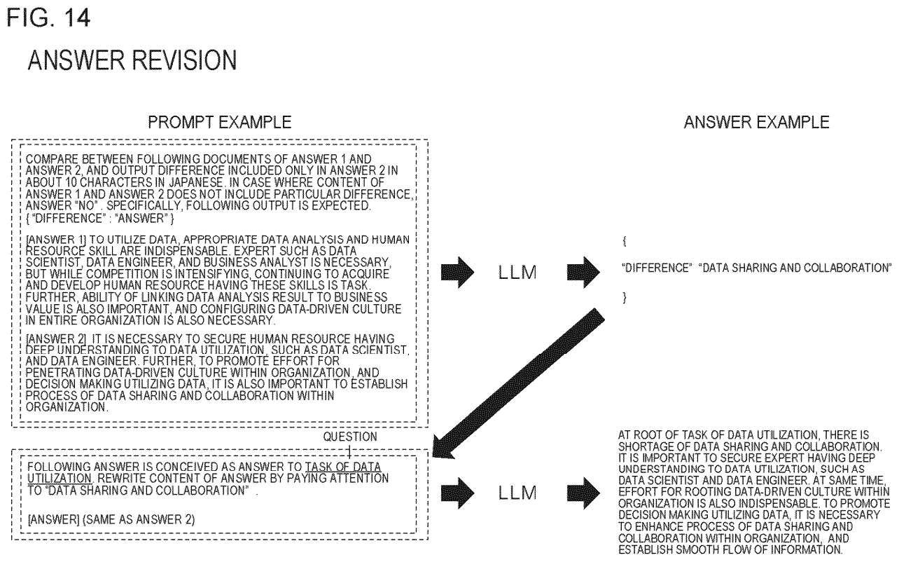

First, as illustrated in FIG. 14, the answer verification unit 123 computes a difference between a first answer and reference information by using the LLM. Various examples are conceived for a prompt in this processing, however, one example is as described in an upper portion of a prompt example in FIG. 14.

The answer verification unit 123 may generate a prompt, for example, by using a template being prepared in advance. For example, the template may be a passage in which a position where a first answer is inserted, and a position where a reference sentence is inserted are blank. Then, the answer verification unit 123 may generate a prompt by inserting the first answer and the reference sentence to a predetermined position of the template. In addition, the answer verification unit 123 may generate a prompt on the basis of a generation model, in place of generating a prompt on the basis of a template. The generation model herein can be achieved by using any widely known technique.

The reference sentence is information acquired by the processing so far. For example, the answer verification unit 123 can use, as the reference sentence, an answer acquired in a preceding loop, or related information used for generation of the answer.

After acquiring the difference, the answer verification unit 123 generates a prompt that revises the first answer by paying attention to the difference. Various examples are conceived for a prompt in this processing, however, one example is as described in a lower portion of the prompt example in FIG. 14.

The answer verification unit 123 may generate a prompt, for example, by using a template being prepared in advance. For example, the template may be a passage in which a position where a question is inserted, a position where a first answer is inserted, and a position where a difference is inserted are blank. Then, the answer verification unit 123 may generate a prompt by inserting the question, the first answer, and the difference to a predetermined position of the template. In addition, the answer verification unit 123 may generate a prompt on the basis of a generation model, in place of generating a prompt on the basis of a template. The generation model herein can be achieved by using any widely known technique.

### Loop Finish Decision Processing S24

The answer verification unit 123 decides whether a loop is to be finished. In a case where the loop is not finished, the processing apparatus 10 proceeds to the question generation processing S25. In a case where the loop is finished, the processing apparatus 10 proceeds to the result output processing S26.

A condition for finishing the loop is determined in advance. Then, the answer verification unit 123 decides whether a finishing condition for finishing the loop is satisfied. In a case where the finishing condition is satisfied, the answer verification unit 123 decides that the loop is finished. On the other hand, in a case where the finishing condition is not satisfied, the answer verification unit 123 decides that the loop is not finished.

The loop finishing condition can be various contents. For example, the loop finishing condition may be any of the following.
The loop is repeated by a predetermined number of times or more
All or all combinations of analysis perspectives to be used are used at least once
A desired retrieval result cannot be acquired any more in the related information retrieval processing S21 (the number of retrieval results becomes equal to or less than a threshold value)

The analysis perspective to be used may be an analysis perspective input in the input acceptance processing S20. In addition, the analysis perspective to be used may be a candidate of an analysis perspective being registered in advance. In addition, the analysis perspective to be used may be an analysis perspective acquired by using the LLM. In addition, the analysis perspective to be used may be a combination of at least two of these analysis perspectives.

### Question Generation Processing S25

The question generation unit 124 generates a hypothesis, based on an answer output in the answer verification processing S23. Then, the question generation unit 124 generates a new question, based on the generated hypothesis. In this way, since specificity of a question increases by including a perspective of a hypothesis, it can be expected that a more interesting answer can be easily acquired in performing a next loop.

In a case where one answer is output in the answer verification processing S23, the question generation unit 124 generates one or a plurality of hypotheses in association with the one answer, and generates one or a plurality of questions. Hereinafter, the processing apparatus 10 repeats the above-described loop by using the one question, or each of the plurality of questions.

On the other hand, in a case where a plurality of answers are output in the answer verification processing S23, the question generation unit 124 generates one or a plurality of hypotheses in association with each of the plurality of answers, and generates one or a plurality of questions. Hereinafter, the processing apparatus 10 repeats the above-described loop by using the one question, or each of the plurality of questions.

Next, processing of generating a hypothesis is described.

The question generation unit 124 generates a hypothesis by inputting, to the LLM, a prompt that generates a hypothesis, based on an answer output in the answer verification processing S23, and acquiring a result.

The question generation unit 124 may generate a prompt, for example, by using a template being prepared in advance. For example, the template may be a passage in which a position where an answer (or a summary thereof) output in the answer verification processing S23 is inserted is blank. Then, the question generation unit 124 may generate a prompt by inserting the answer (or the summary thereof) output in the answer verification processing S23 to a predetermined position of the template. In addition, the question generation unit 124 may generate a prompt on the basis of a generation model, in place of generating a prompt on the basis of a template. The generation model herein can be achieved by using any widely known technique.

Note that, a hypothesis to be generated herein may be a hypothesis of a next analysis perspective of an answer output in the answer verification processing S23. Specifically, the question generation unit 124 may generate, in the question generation processing S25 in the n-th loop (where n is an integer of 1 or more), a hypothesis of an analysis perspective in the (n+1)-th loop of an answer output in the answer verification processing S23 in the n-th loop. For example, it is assumed that, regarding an analysis perspective being a “task” in the n-th loop, an answer (task) thereof is output in the answer verification processing S23 in the n-th loop. In this case, in the question generation processing S25 in the n-th loop, the question generation unit 124 can generate a hypothesis of a cause (analysis perspective in the (n+1)-th loop) of the answer (task) output in the answer verification processing S23 in the n-th loop.

The next analysis perspective is an analysis perspective (one analysis perspective, or a combination of analysis perspectives) not being used in the loop so far.

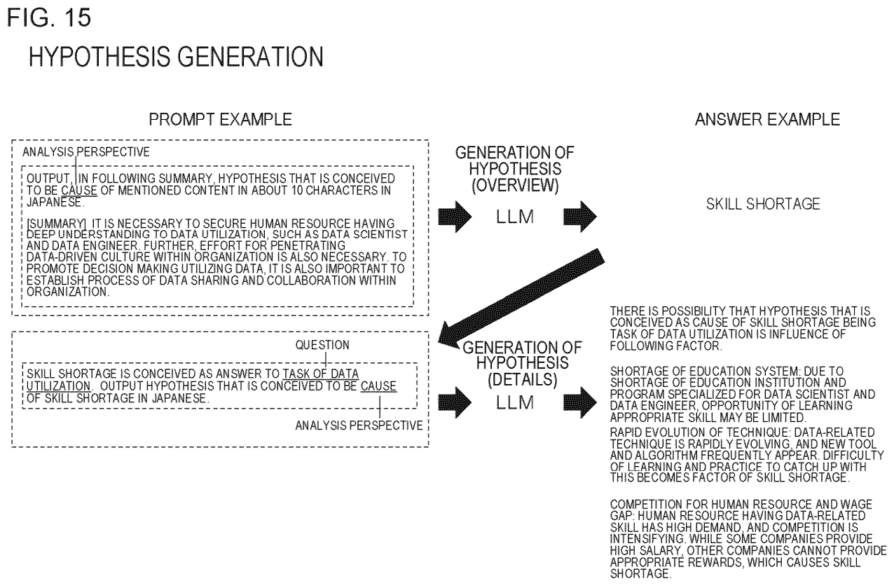

Herein, one example of hypothesis generation is described by using FIG. 15. Note that, in an example in FIG. 15, a 2-step configuration in which an overview of a hypothesis is generated, and then, details of the hypothesis are generated is configured. By configuring a 2-step configuration as described above, a hypothesis of high accuracy is generated. However, a prompt directly asking for “a hypothesis of a next analysis perspective of an answer output in the answer verification processing S23” may be generated, and details of a hypothesis may be generated by 1-step. By configuring as described above, a hypothesis of sufficient accuracy to some extent is also generated.

In the example in FIG. 15, first, as illustrated in an upper portion of a prompt example in FIG. 15, the question generation unit 124 generates a prompt that generates an overview of a hypothesis of a next analysis perspective of an answer output in the answer verification processing S23. Then, the question generation unit 124 inputs the prompt to the LLM, and acquires the overview of the hypothesis.

Note that, as illustrated in the example in FIG. 15, the question generation unit 124 may generate a prompt by using a summary of an answer output in the answer verification processing S23, in place of the answer. The question generation unit 124 can generate the summary by using the LLM.

The question generation unit 124 may generate a prompt, for example, by using a template being prepared in advance. For example, the template may be a passage in which a position where an answer (or a summary thereof) output in the answer verification processing S23 is inserted, and a position where a next analysis perspective is inserted are blank. Then, the question generation unit 124 may generate a prompt by inserting the answer (or the summary thereof) output in the answer verification processing S23, and the next analysis perspective to a predetermined position of the template. In addition, the question generation unit 124 may generate a prompt on the basis of a generation model, in place of generating a prompt on the basis of a template. The generation model herein can be achieved by using any widely known technique.

After acquiring the overview of the hypothesis, as illustrated in a lower portion of the prompt example in FIG. 15, the question generation unit 124 deepens the acquired overview of the hypothesis, and generates a prompt that generates details of the hypothesis. Then, the question generation unit 124 acquires the details of the hypothesis by inputting the prompt to the LLM.

The prompt that generates details of the hypothesis becomes a content asking for details of a hypothesis of a next analysis perspective of an overview of the hypothesis. The “next analysis perspective” herein can be set as a same analysis perspective as the “next analysis perspective” used at a time of generating the overview of the hypothesis. Specifically, the question generation unit 124 can perform generation of an overview of a hypothesis, and generation of details of the hypothesis by using a same analysis perspective, as a next analysis perspective.

In the example in FIG. 15, “skill shortage” is acquired as an overview of a hypothesis of a cause (next analysis perspective) of an answer output in the answer verification processing S23. Then, a prompt asking for a hypothesis of the cause (next analysis perspective) of “skill shortage” (overview of a hypothesis) is generated.

The question generation unit 124 may generate a prompt, for example, by using a template being prepared in advance. For example, the template may be a passage in which a position where an overview of a hypothesis is inserted, and a position where a next analysis perspective is inserted are blank. Then, the question generation unit 124 may generate a prompt by inserting the overview of the hypothesis, and the next analysis perspective to a predetermined position of the template. In addition, the template may be configured in such a way that a position where a question is inserted is blank. In addition, the question generation unit 124 may generate a prompt on the basis of a generation model, in place of generating a prompt on the basis of a template. The generation model herein can be achieved by using any widely known technique.

Next, processing of generating a question, based on a hypothesis, is described.

The question generation unit 124 generates a question asking for a next analysis perspective, based on a generated hypothesis. The “next analysis perspective” herein can be set as a same analysis perspective as the “next analysis perspective” used at a time of generating the hypothesis. Specifically, the question generation unit 124 performs generation of an overview of a hypothesis, generation of details of the hypothesis, and generation of a new question by using a same analysis perspective, as a next analysis perspective.

For example, it is assumed that, regarding an analysis perspective being a “task” in the n-th loop, an answer (task) thereof is output in the answer verification processing S23 in the n-th loop. In this case, in the question generation processing S25 in the n-th loop, the question generation unit 124 generates a hypothesis of a cause (analysis perspective in the (n+1)-th loop) of the answer (task) output in the answer verification processing S23 in the n-th loop. Then, in the question generation processing S25 in the n-th loop, the question generation unit 124 can generate a question asking for a cause (analysis perspective in the (n+1)-th loop) of the hypothesis.

The question generation unit 124 may generate a question, for example, by using a template being prepared in advance. For example, the template may be a passage in which a position where a hypothesis and a next analysis perspective are inserted is blank. Then, the question generation unit 124 may generate a question by inserting the hypothesis and the next analysis perspective to a predetermined position of the template. In addition, the question generation unit 124 may generate a question on the basis of a generation model, in place of generating a question on the basis of a template. The generation model herein can be achieved by using any widely known technique.

### Result Output Processing S26

The result output unit 13 outputs, toward a user, an answer screen indicating an answer output from the answer verification unit 123 in the answer verification processing S23. The result output unit 13 may display an answer screen via an output apparatus such as a display or a projection apparatus. In addition, in a case where the processing apparatus 10 is a server, the result output unit 13 may transmit an answer screen toward a client terminal.

As a result of performing a loop a plurality of times, an answer output from the answer verification unit 123 in the answer verification processing S23 may become plural. For example, the processing apparatus 10 to acquire a result in which answers in terms of various analysis perspectives are linked in a row in order of execution of the loop by repeating the loop. The result output unit 13 may output, toward a user, an answer screen on which the plurality of answers are displayed as a list. In addition, the result output unit 13 may output, toward a user, an answer screen on which an answer selected from among the plurality of answers in accordance with a predetermined rule is displayed.

Further, the result output unit 13 may further output related information used in acquiring each answer. For example, the result output unit 13 may indicate, on an answer screen, each answer, and related information used in acquiring each answer in association with each other. In addition, the result output unit 13 may specify one answer on an answer screen, and output, on the answer screen or on another screen (e.g., on another window), related information used in acquiring the specified answer in response to a user input of causing to display the related information.

Further, the result output unit 13 may further output a question to each answer. For example, the result output unit 13 may indicate, on an answer screen, each answer, and a question to each answer in association with each other. In addition, the result output unit 13 may specify one answer on an answer screen, and output, on the answer screen or on another screen (e.g., on another window), a question to the specified answer in response to a user input of causing to display the question.

Further, the result output unit 13 may further output an analysis perspective used in acquiring each answer. For example, the result output unit 13 may indicate, on an answer screen, each answer, and an analysis perspective used in acquiring each answer in association with each other. In addition, the result output unit 13 may specify one answer on an answer screen, and output, on the answer screen or on another screen (e.g., on another window), an analysis perspective used in acquiring the specified answer in response to a user input of causing to display the analysis perspective.

Further, the result output unit 13 may further output a hypothesis (including an overview and details) used in acquiring each answer. For example, the result output unit 13 may indicate, on an answer screen, each answer, and a hypothesis used in acquiring each answer in association with each other. In addition, the result output unit 13 may specify one answer on an answer screen, and output, on the answer screen or on another screen (e.g., on another window), a hypothesis used in acquiring the specified answer in response to a user input of causing to display the hypothesis.

Note that, the amount of information to be output from the above-described result output unit 13 may become enormous. In view of the above, the result output unit 13 may output the above-described information by using various display methods such as a tree structure or a graph. A specific example of this display is described in the following example embodiment.

### Advantageous Effect

In the processing apparatus 10 according to the second example embodiment, an advantageous effect similar to that of the processing apparatus 10 according to the first example embodiment is achieved.

Further, the processing apparatus 10 can automatically generate a prompt for acquiring a desired answer, based on an input question and analysis perspective, by a method on the basis of a template or on the basis of a generation model. Therefore, it is possible to reduce time and effort for generating a template by a user.

Further, the processing apparatus 10 can automatically collect pieces of related information necessary for acquiring a desired answer by cross-sectionally searching for a plurality of information sources, based on a generated question. Further, the processing apparatus 10 can increase accuracy and specificity of an answer by generating an answer to a question with use of the collected pieces of related information.

Further, the processing apparatus 10 can generate a plurality of questions from an acquired answer, and perform collection of the above-described pieces of related information and generation of an answer by individually using the plurality of questions. According to the processing apparatus 10 as described above, generation of an answer in which thought is allowed to flow and considered from various perspectives is achieved.

The processing apparatus 10 can reproduce a deep thinking process by a human in an imitative manner and automate a desired analysis of a perspective by implementing question generation and cross-sectional related information search in a chain reaction manner. Further, for example, allowing thought to flow as described above or using various pieces of related information enables to discover an unexpected relationship, or new measures and ideas that a human could not notice.

Further, the processing apparatus 10 according to the second example embodiment can generate an answer to a question by combining the LLM and the RAG. Using the RAG enables to improve quality of an answer to be output from the LLM. Combining the LLM and the RAG enables to extract various insights from collected pieces of related information, and making great progress of data utilization in various scenes such as information search, hypothesis verification, and idea support is expected.

Meanwhile, in recent years, an attempt to generate a data infrastructure of an entire organization, and cancel data siloing has been made. However, there is a problem that the number of users to be used does not increase, even if a data infrastructure of an entire organization is generated, and data siloing is canceled. The following examples are exemplified as a cause of this problem.

### Problem in Prompt Generation

In order to extract information skillfully from the LLM, it is necessary to write a prompt skillfully. Specifically, a user is required to have a skill of writing a prompt skillfully. Since users sufficiently with a skill as described above are less, use of a data infrastructure of the entire organization does not progress as expected.

### Problem in Related Information Utilization

In order to extract information skillfully from the LLM, it is necessary to use related information skillfully. Specifically, a user is required to have a skill of skillfully retrieving and using related information. This skill includes a skill of determining what kind of related information is to be utilized to acquire an intended answer, in addition to an information retrieval skill. Since users sufficiently with a skill as described above are less, use of a data infrastructure of the entire organization does not progress as expected.

### Deepening Thought

There is a case where a desired answer is acquired by repeating thought from various perspectives. In this case, a user is required to have a skill of repeating thought from various perspectives, while using a data infrastructure of the entirety organization. Since users sufficiently with a skill as described above are less, use of a data infrastructure of the entire organization does not progress as expected.

The processing apparatus 10 according to the second example embodiment is configured in such a way as to enable to solve problems as described above. Specifically, the processing apparatus 10 automatically performs prompt generation, related information utilization, and deepening of thought. Work to be done by a user is inputting a question and an analysis perspective first. Thereafter, the processing apparatus 10 automatically performs prompt generation, related information utilization, and deepening of thought, and outputs a result.

By using the processing apparatus 10 as described above, it is expected to solve the above-described problem, specifically, a problem that use of a data infrastructure of the entire organization does not progress as expected.

### Third Example Embodiment

A processing apparatus 10 according to a third example embodiment can output a result of thought to a question by a characteristic tree structure in result output processing S26. Hereinafter, details are described.

As described in the second example embodiment, the processing apparatus 10 can acquire a result in which answers in terms of various analysis perspectives are linked in a row in order of execution of a loop by repeating the loop. As described above, since there is a case where a plurality of questions are generated by a one-time loop, a result in which answers are linked in a row may become the one in which the answers are branched into a plurality of lines at a midpoint, instead of the one in which the answers are linearly linked by one line. For example, in a case where m questions are generated in a loop at a certain time, thereafter, answers are branched into m lines in the loop at the certain time being a base point.

A result output unit 13 can display a plurality of answers acquired by a loop of a plurality of times by a tree structure indicating a row or a branching status as described above. Specifically, the result output unit 13 can generate and output a result screen on which a relationship among a plurality of answers acquired by repeatedly performing a loop (processing) is displayed by a tree structure.

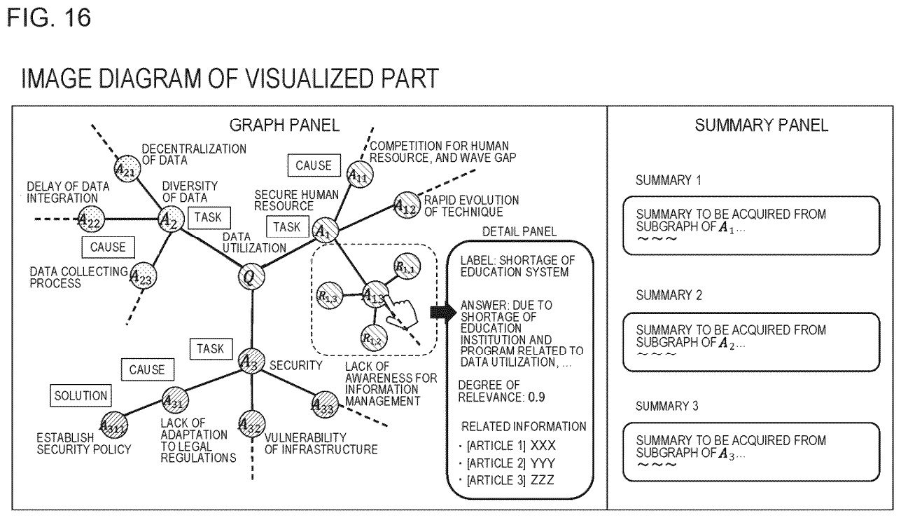

FIG. 16 illustrates one example of a result screen output from the result output unit 13. The illustrated result screen includes a graph panel, a summary panel, and a detail panel. Note that, the result screen may not include at least one of the summary panel and the detail panel.

A tree structure indicating a relationship among a plurality of answers acquired by repeatedly performing a loop (processing) is displayed on the graph panel.

A node Q is a node associated with a question input in input acceptance processing S20. The result output unit 13 can display a question in association with the node Q. However, in a case where a question is a relatively long sentence, the amount of information to be displayed on the result screen at once becomes large, and thereby it makes difficult to visually recognize. In view of the above, as illustrated in FIG. 16, the result output unit 13 can display a label (“data utilization” in FIG. 16) indicating a question in short. Note that, the result output unit 13 may display a question or a label in response to a user input or the like of specifying the node Q by mouseover or another operation, without displaying the question or the label under a normal circumstance. Further, the result output unit 13 may display a question or a label within a display area of the node Q. Specifically, the result output unit 13 may display a question or a label, in place of a character “Q” in FIG. 16.

A plurality of nodes A (a node to which a character A is attached) are nodes associated with an answer output in answer verification processing S23. As described above, in some cases, one answer is output by a one-time loop, and in other cases, a plurality of answers are output by a one-time loop. Nodes of a plurality of answers generated by a same loop are displayed on a same level. In an example in FIG. 16, the result output unit 13 displays three nodes A₁ to A₃ linked to the node Q. Three answers each associated with the nodes A₁ to A₃ are answers generated by a one-time loop using a question at the node Q. In the example in FIG. 16, the three nodes A₁ to A₃ each associated with the three answers are linked to the node Q in parallel, and are displayed on a same level.

Further, the result output unit 13 can display an answer in association with the node A. However, in a case where an answer is a relatively long sentence, the amount of information to be displayed on the result screen at once becomes large, and thereby it makes difficult to visually recognize. In view of the above, as illustrated in FIG. 16, the result output unit 13 may display a label (“securing a human resource” or the like in FIG. 16) indicating an answer in short. Note that, the result output unit 13 may display an answer or a label in response to a user input or the like of specifying the node A by mouseover or another operation, without displaying the answer or the label under a normal circumstance. Further, the result output unit 13 may display an answer or a label within a display area of the node A. Specifically, the result output unit 13 may display an answer or a label, in place of a character “A₁” or the like in FIG. 16.

Further, in the example in FIG. 16, the result output unit 13 displays an analysis perspective (“a task,” “a cause, “a solution”, and the like in FIG. 16) used for acquiring an answer on each level. Note that, the result output unit 13 may display an analysis perspective in response to a user input or the like of specifying the node A by mouseover or another operation, without displaying the analysis perspective under a normal circumstance. Further, the result output unit 13 may display an analysis perspective within a display area of the node A. Specifically, the result output unit 13 may display an analysis perspective, in place of the character “A₁” or the like in FIG. 16.

Further, in the example in FIG. 16, the result output unit 13 displays, on the detail panel, information related to an answer at one node A in response to a user input of specifying the one node A by mouseover or another operation.

The information related to the answer includes at least one of a question, an answer, an analysis perspective, a degree of relevance between a question and an answer, a label indicating an answer in short, a summary of an answer, related information used for acquiring an answer, a summary of related information, and a hypothesis (including an overview and details). Note that, the amount of information of the related information is likely to increase. In view of the above, as illustrated in FIG. 16, the result output unit 13 may display, on the detail panel, only a heading of the related information as a list. Then, the result output unit 13 may display the related information in response to a user input of specifying a heading of one piece of related information by mouseover or another operation.

Further, in the example in FIG. 16, the result output unit 13 displays a node R associated with each of at least one piece of related information used for acquiring an answer at one node A in response to a user input of specifying the one node A. The result output unit 13 may display related information, or a summary of the related information in response to a user input of specifying the one node R by mouseover or another operation.

Further, in the example in FIG. 16, the result output unit 13 displays, on the summary panel, a summary of an answer at a node group being a part of a tree structure and composed of a plurality of nodes hanging on a same node. A user may also specify the node group.

“Summary 1” illustrated in FIG. 16 is a summary of an answer at a node group composed of a plurality of nodes A hanging on the node A₁. “Summary 2” illustrated in FIG. 16 is a summary of an answer at a node group composed of a plurality of nodes A hanging on the node A₂. “Summary 3” illustrated in FIG. 16 is a summary of an answer at a node group composed of a plurality of nodes A hanging on the node A₃.

Note that, although the example in FIG. 16 does not clearly illustrate, the result output unit 13 may change a display pattern (a color, a size, or the like) of a node, based on a predetermined score. The score may be, for example, a score proportional to a degree of relevance of an answer to a question or the number of edges connected to each node, or the like. A search unit 12 or the result output unit 13 can compute a score for each node (for each answer) in accordance with a predetermined score computation rule.

Further, although the example in FIG. 16 does not clearly illustrate, the result output unit 13 may change a display pattern (a color, a type of a line, a thickness of a line, or the like) of an edge in accordance with a predetermined rule. For example, the result output unit 13 may set an edge on a same level, as a same display pattern, and differentiate a display pattern of the edge for each level.

Further, although the example in FIG. 16 does not clearly illustrate, the result output unit 13 may group a plurality of nodes, and display the group in an identifiable manner. For example, the result output unit 13 may display a border or the like embracing a node belonging to a same group. In addition, the result output unit 13 may set a node belonging to a same group, as a same display pattern (a color, a size, or the like), and differentiate a display pattern of the node for each group.

There are various grouping methods, but, for example, grouping may be performed by gathering similar nodes, based on similarity of a question, or a similarity of an answer. For example, it is possible to compute similarity of a question or similarity of an answer by using a technique for computing the above-described similarity between passages. The search unit 12 or the result output unit 13 can perform the grouping processing.

Next, processing of generating a “label” and a “summary” is described. The result output unit 13 can generate at least one of a label and a summary by using an LLM, and display, on the above-described result screen, at least one of the generated label and summary.

The result output unit 13 may generate a prompt, for example, by using a template being prepared in advance. For example, the template may be a passage in which a position where a target (an answer, a question, related information, or the like) for which a label or a summary is generated is inserted is blank. Then, the result output unit 13 may generate a prompt by inserting the target (the answer, the question, the related information, or the like) for which the label or the summary is generated to a predetermined position of the template. In addition, the result output unit 13 may generate a prompt on the basis of a generation model, in place of generating a prompt on the basis of a template. The generation model herein can be achieved by using any widely known technique.

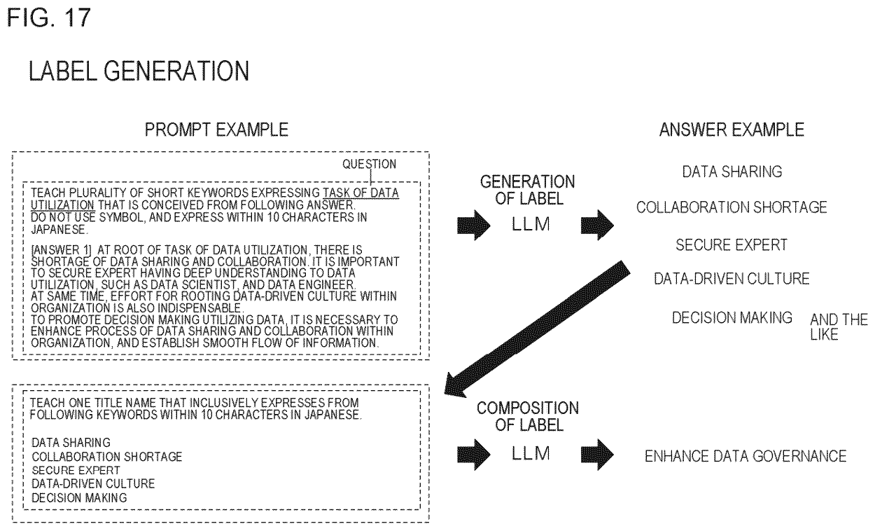

Herein, one example of label generation is described by using FIG. 17. Note that, in an example in FIG. 17, a 2-step configuration in which a plurality of keywords are determined (e.g., use of a technique such as the LLM or MultipartieRank), and then, a label is generated based on the plurality of determined keywords is configured. By configuring a 2-step configuration as described above, a label of high accuracy is generated. However, a prompt directly asking for “a label that expresses a target passage in short” may be generated, and a label may be generated by 1-step. Further, a keyword determined by using a technique such as the LLM or the MultipartieRank may be used as a label. By configuring as described above, a label of sufficient accuracy to some extent is also generated.

In the example in FIG. 17, first, as illustrated in an upper portion of a prompt example in FIG. 17, the result output unit 13 generates a prompt asking for a plurality of keywords expressing, in short, a target (answer) for which a label is generated. Then, the result output unit 13 acquires a plurality of keywords by inputting the prompt to the LLM.

After acquiring the plurality of keywords, as illustrated in a lower portion of the prompt example in FIG. 17, the result output unit 13 generates a prompt asking for a title expressing the plurality of acquired keywords in a comprehensive manner. Then, the result output unit 13 acquires a tile by inputting the prompt to the LLM. This tile becomes a label.

As illustrated in the prompt example in FIG. 17, it is possible to acquire a label of a desired length by adding character limit to an answer to be output from the LLM.

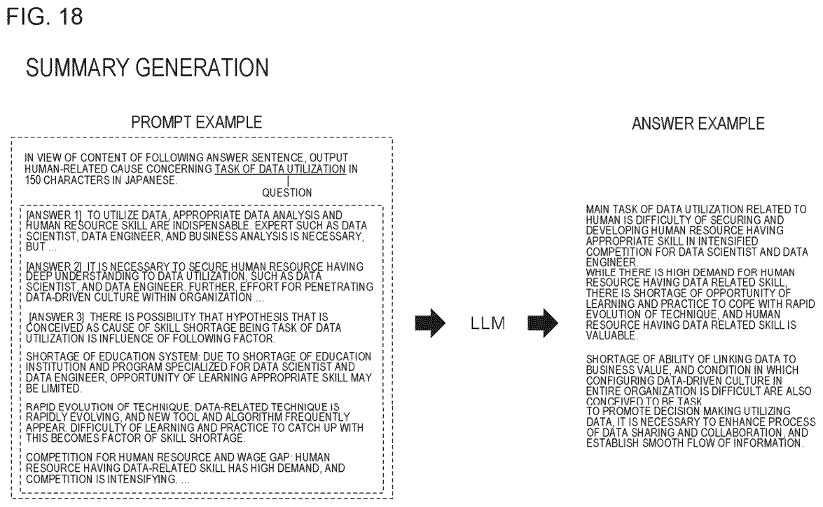

Next, one example of summary generation is described by using FIG. 18. In an example in FIG. 18, the result output unit 13 generates a prompt asking for an answer to a predetermined question within a predetermined number of characters, based on a target (answer) for which a summary is generated. In this way, adding character limit to an answer to be output from the LLM enables to acquire a summary of a desired length.

Other configurations of the processing apparatus 10 according to the third example embodiment are similar to the configurations of the processing apparatus 10 according to the first and second example embodiments.

In the processing apparatus 10 according to the third example embodiment, an advantageous effect similar to that of the processing apparatus 10 according to the first and second example embodiments is achieved. Further, according to the processing apparatus 10, a result acquired by characteristic processing described in the second example embodiment can be displayed by a characteristic tree structure.

As described in the second example embodiment, according to the processing apparatus 10, implementing question generation, and cross-sectional related information search in a chain reaction manner enables to reproduce a deep thinking process by a human in an imitative manner, and automate a desired analysis of a perspective. Further, for example, allowing thought to flow or using various pieces of related information enables to discover an unexpected relationship, or new measures and ideas that a human could not notice.

However, in a case where processing of imitating complicated thought as described above is performed, an acquired result may also include a complicated relationship. Displaying a result on a complicated relationship as described above by a tree structure allows for a user to systematically recognize a result. Consequently, the user can easily understand the result.

### Modification Examples

### Modification Example 1

A search unit 12 may not include an information retrieval unit 121. In this case, related information retrieval processing S21 is not performed. Then, an information apparatus 10 performs the above-described processing, without using related information. Even in a case where the above-described processing is repeated without using related information, it is possible to acquire an answer to a question with sufficient accuracy to some extent.

### Modification Example 2

The search unit 12 may not include an answer verification unit 123. In this case, answer verification processing S23 is not performed. Then, the processing apparatus 10 performs pieces of processing thereafter (generation of a question, loop processing based on a new question, output of a result, and the like), based on all first answers output in answer generation processing S22. In a case of this modification example, although an inconvenience that pieces of processing thereafter are performed based on a first answer in which a degree of relevance to a question is low cannot be avoided, it is possible to acquire an answer to a question with sufficient accuracy to some extent.

### Modification Example 3

In the third example embodiment, the processing apparatus 10 outputs a result screen with a tree structure. Specifically, the processing apparatus 10 that generates an answer to a question by processing as described in the second example embodiment further outputs a result screen with a tree structure.

In the modification example, an information providing apparatus being physically and/or logically separated from the processing apparatus 10 that generates an answer to a question by processing as described in the second example embodiment acquires data on a result of an answer to a question from the processing apparatus 10. Then, the information providing apparatus outputs a result screen with a tree structure by processing as described in the third example embodiment. One example of a hardware configuration of the information providing apparatus is similar to that of the processing apparatus 10, and, for example, is illustrated in FIG. 4. Also in the modification example, an advantageous effect similar to that of the above-described example embodiments is achieved.

As described above, while the present disclosure has been described with reference to the example embodiments, the present disclosure is not limited to the above-described example embodiments. A configuration and details of the present disclosure can be changed in various ways comprehensible to a person skilled in the art within the scope of the present disclosure. Further, each example embodiment can be combined with another example embodiment as necessary.

Further, in a plurality of flowcharts used in the above description, a plurality of processes (pieces of processing) are described in order. However, the order of execution of processes to be performed in each example embodiment is not limited to the order of description. In each example embodiment, the illustrated order of processes can be changed within a range that does not adversely affect a content.

A part or all of the above-described example embodiments may also be described as the following supplementary notes, but is not limited to the following.
1. A processing apparatus including:
   an input acceptance unit that accepts an input of a question and an analysis perspective; and
   a search unit that repeatedly performs processing of generating an answer by inputting a prompt indicating a question and an analysis perspective to a large language model with use of an input question, and a new question generated based on the answer.
2. The processing apparatus according to supplementary note 1, wherein
   the search unit further includes a question generation unit that generates a hypothesis, based on the answer, and generates the new question, based on a generated hypothesis.
3. The processing apparatus according to supplementary note 2, wherein
   the question generation unit generates a hypothesis by acquiring a result by inputting, to a large language model, a prompt that generates a hypothesis related to a predetermined analysis perspective, based on the answer.
4. The processing apparatus according to supplementary note 2, wherein
   the question generation unit includes, in a prompt indicating the new question, a generated hypothesis.
5. The processing apparatus according to any one of supplementary notes 1 to 4, wherein
   the search unit includes
      an answer generation unit that generates a prompt indicating a question and an analysis perspective, and generates a first answer by inputting a generated prompt to a large language model, and
      an answer verification unit that decides whether a degree of relevance between the first answer and a question satisfies a passing condition, and outputs, as an answer to a question, the first answer that satisfies the passing condition.
6. The processing apparatus according to supplementary note 5, wherein
   the answer verification unit revises the first answer that does not satisfy the passing condition, and outputs, as an answer to a question, the first answer that satisfies the passing condition after revision.
7. The processing apparatus according to supplementary note 6, wherein
   the answer verification unit computes a difference between the first answer and reference information, acquires a result by inputting, to a large language model, a prompt that revises the first answer by paying attention to the difference and thereby revises the first answer.
8. The processing apparatus according to any one of supplementary notes 5 to 7, wherein
   the answer verification unit discards the first answer that does not satisfy the passing condition.
9. The processing apparatus according to any one of supplementary notes 1 to 8, wherein
   the search unit includes
      an information retrieval unit that retrieves related information related to a question, and
      an answer generation unit that generates a prompt by using a question, an analysis perspective, and the related information, and generates an answer by inputting a generated prompt to a large language model.
10. The processing apparatus according to any one of supplementary notes 1 to 9, wherein
   the search unit differentiates, in the processing to be repeatedly performed, an analysis perspective to be used in the processing at each time.
11. The processing apparatus according to any one of supplementary notes 1 to 10, further including
   a result output unit that generates and outputs a result screen on which a relationship between a plurality of the answers acquired by repeatedly performing the processing is displayed by a tree structure.
12. The processing apparatus according to supplementary note 11, wherein
   the result output unit displays, in the tree structure, information related to the answer in association with a node associated with each of a plurality of the answers.
13. The processing apparatus according to supplementary note 12, wherein
   the result output unit generates at least one of a label and a summary by using a large language model, and displays at least one of a generated label and a generated summary.
14. The processing apparatus according to any one of supplementary notes 11 to 13, wherein
   the result output unit generates and displays, by using a large language model, a summary of the answer at a node group being a part of the tree structure, the node group being composed of a plurality of nodes hanging on a same node.
15. A processing method including,
   by one or more computers:
      accepting an input of a question and an analysis perspective; and
      repeatedly performing processing of generating an answer by inputting a prompt indicating a question and an analysis perspective to a large language model with use of an input question, and a new question generated based on the answer.
16. A program that causes a computer to function as:
   an input acceptance unit that accepts an input of a question and an analysis perspective; and
   a search unit that repeatedly performs processing of generating an answer by inputting a prompt indicating a question and an analysis perspective to a large language model with use of an input question, and a new question generated based on the answer.

A part or all of supplementary notes 2 to 14 depending on the processing apparatus of supplementary note 1 described above may also depend on the processing method of supplementary note 15, and the program of supplementary note 16 by dependency similar to dependency between supplementary note 1, and supplementary notes 2 to 14. Further, a part or all of a configuration described as a supplementary note can be achieved in various hardware, software, various recording means for recording software, or a system in a range that does not depart from the above-described each example embodiment.
10 Processing apparatus
11 Input acceptance unit
12 Search unit
121 Information retrieval unit
122 Answer generation unit
123 Answer verification unit
124 Question generation unit
1A Processor
2A Memory
3A Input/output I/F
4A Peripheral circuit
5A Bus

1. A processing apparatus comprising:
at least one memory configured to store one or more instructions; and
at least one processor configured to execute the one or more instructions to:
accept an input of a question and an analysis perspective; and
repeatedly perform processing of generating an answer by inputting a prompt indicating a question and an analysis perspective to a large language model with use of an input question, and a new question generated based on the answer.

2. The processing apparatus according to claim 1, wherein
the at least one processor is further configured to execute the one or more instructions to generate a hypothesis, based on the answer, and generate the new question, based on a generated hypothesis.

3. The processing apparatus according to claim 2, wherein
the at least one processor is further configured to execute the one or more instructions to generate a hypothesis by acquiring a result by inputting, to a large language model, a prompt that generates a hypothesis related to a predetermined analysis perspective, based on the answer.

4. The processing apparatus according to claim 2, wherein
the at least one processor is further configured to execute the one or more instructions to include, in a prompt indicating the new question, a generated hypothesis.

5. The processing apparatus according to claim 1, wherein
the at least one processor is further configured to execute the one or more instructions to
generate a prompt indicating a question and an analysis perspective,
generate a first answer by inputting a generated prompt to a large language model,
decides whether a degree of relevance between the first answer and a question satisfies a passing condition, and
output, as an answer to a question, the first answer that satisfies the passing condition.

6. The processing apparatus according to claim 5, wherein
the at least one processor is further configured to execute the one or more instructions to revise the first answer that does not satisfy the passing condition, and output, as an answer to a question, the first answer that satisfies the passing condition after revision.

7. The processing apparatus according to claim 6, wherein
the at least one processor is further configured to execute the one or more instructions to compute a difference between the first answer and reference information, acquire a result by inputting, to a large language model, a prompt that revises the first answer by paying attention to the difference, and thereby revise the first answer.

8. The processing apparatus according to claim 5, wherein
the at least one processor is further configured to execute the one or more instructions to discard the first answer that does not satisfy the passing condition.

9. The processing apparatus according to claim 1, wherein
the at least one processor is further configured to execute the one or more instructions to
retrieve related information related to a question,
generate a prompt by using a question, an analysis perspective, and the related information, and
generate an answer by inputting a generated prompt to a large language model.

10. The processing apparatus according to claim 1, wherein
the at least one processor is further configured to execute the one or more instructions to differentiate, in the processing to be repeatedly performed, an analysis perspective to be used in the processing at each time.

11. The processing apparatus according to claim 1, wherein
the at least one processor is further configured to execute the one or more instructions to generate and output a result screen on which a relationship between a plurality of the answers acquired by repeatedly performing the processing is displayed by a tree structure.

12. The processing apparatus according to claim 11, wherein
the at least one processor is further configured to execute the one or more instructions to display, in the tree structure, information related to the answer in association with a node associated with each of a plurality of the answers.

13. The processing apparatus according to claim 12, wherein
the at least one processor is further configured to execute the one or more instructions to generate at least one of a label and a summary by using a large language model, and display at least one of a generated label and a generated summary.

14. The processing apparatus according to claim 11, wherein
the at least one processor is further configured to execute the one or more instructions to generate and display, by using a large language model, a summary of the answer at a node group being a part of the tree structure, the node group being composed of a plurality of nodes hanging on a same node.

15. A processing method comprising,
by one or more computers:
accepting an input of a question and an analysis perspective; and
repeatedly performing processing of generating an answer by inputting a prompt indicating a question and an analysis perspective to a large language model with use of an input question, and a new question generated based on the answer.

16. The processing method according to claim 15, wherein
the one or more computers generates a hypothesis, based on the answer, and generates the new question, based on a generated hypothesis.

17. The processing method according to claim 16, wherein
the one or more computers generates a hypothesis by acquiring a result by inputting, to a large language model, a prompt that generates a hypothesis related to a predetermined analysis perspective, based on the answer.

18. A non-transitory computer-readable medium storing a program that causes a computer to:
accept an input of a question and an analysis perspective; and
repeatedly perform processing of generating an answer by inputting a prompt indicating a question and an analysis perspective to a large language model with use of an input question, and a new question generated based on the answer.

19. The non-transitory computer-readable medium according to claim 18, wherein
the program causes the computer to generate a hypothesis, based on the answer, and generate the new question, based on a generated hypothesis.

20. The non-transitory computer-readable medium according to claim 19, wherein
the program causes the computer to generate a hypothesis by acquiring a result by inputting, to a large language model, a prompt that generates a hypothesis related to a predetermined analysis perspective, based on the answer.
